(19) United States
(12) Patent Application Publication
(10) Pub. No.: US 2017/0070468 A1
(43) Pub. Date: Mar. 9, 2017

(54) Communication And Notification System For A Social Collaboration Application

(71) Applicant: Minty Networks, LLC, Alpharetta, GA (US)

(72) Inventors: Albert Einstein Renshaw, Alpharetta, GA (US); Connor Matthew Duggan, Victoria (CA)

(21) Appl. No.: 14/853,599

(22) Filed: Sep. 14, 2015

Related U.S. Application Data
(63) Continuation of application No. 14/845,484, filed on Sep. 4, 2015.

(51) Int. Cl. H04L 12/58; H04L 29/08; H04L 29/06

(52) U.S. Cl. CPC H04L 51/26; H04L 65/403; H04L 51/32; H04L 67/26

(57) ABSTRACT

Technologies are described herein providing for prioritizing messages and bumping messages in a social collaboration application. In some examples, an input may be received that a message is a priority message. If prioritization is permitted, to notification of the prioritized message may be pushed to intended recipients of the message. In other examples, an input may be received that a message is to be bumped to the top of an information feed of a recipient that has received but not viewed the message. If the bump operation is permitted, the message is moved to the top of the information feed for the users that have not viewed the message.

### CROSS REFERENCE TO RELATED APPLICATIONS

This application is a continuation of co-pending U.S. application Ser. No. 14/845,484 filed Sep. 4, 2015 entitled “Communication and Notification System for a Social Collaboration Application,” which is incorporated herein by reference in its entirety.

### BACKGROUND

Collaboration and information sharing services (“collaboration services”) are becoming increasingly common Collaboration services can provide users a way to communicate with other users. A listing of users are sometimes narrowed to specific users that a user identifies as one to which communication can occur. The users can share their status, provide news about their life and family, share pictures, and other information they desire to share with their fellow users.

Conventional collaboration services receive communications from one user and provide that communication to other users that are related in some manner to the sending user. Typically, the manner in which the communications are presented to the receiving user are from a time-based order in which the communications are sent from other sending users to the receiving users. Communications received for a particular user can be placed in a queue in the order in which they were received.

It is with respect to these and other considerations that the disclosure made herein is presented.

### SUMMARY

The following detailed description is directed to technologies for a communication and notification system for use in a social collaboration application. In some examples, a priority communication system is described. The priority communication system can receive an input from a user that intended recipients of the priority communication are to be notified that the priority message has been received at the recipients' user devices. In examples, a notification user interface (“UI”) may be modified so that the notification associated with the priority message is identified as a priority message.

In other examples, a user may bump a communication to provide notification to intended recipients. The communication and notification system can receive an input from a user that a communication is to be placed at or near the beginning of other users' information feeds. The communication can be placed at or near the top of users that have not previously viewed the communication. In some examples, the user may be limited to the number of times a bump action can be used.

It should be appreciated that the above-described subject matter may be implemented as a computer-implemented method, computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure

### BRIEF DESCRIPTION OF THE DRAWINGS

FIG. 1 is a system diagram showing one illustrative operating environment that may be used to implement various embodiments described herein.

FIG. 2 is user interface (“UI”) diagram showing a user interface for a communication and notification system for use in a social collaboration application.

FIG. 3 is a user interface diagram showing a user interface with a data type selection UI used to generate a message.

FIG. 4 is a UI diagram showing a message input interface configured to receive an input of the message to be provided to one or more intended recipients of the message.

FIG. 5 is a notification user interface showing notifications of messages with default priorities.

FIG. 6 is a notification user interface showing notifications in which a notification has been changed to indicate that the notification is a high priority message that has been received at the collaboration application server.

FIG. 7 is an information feed interface with information feeds.

FIG. 8 is an illustration of a postings interface showing a bump feature.

FIG. 9A is an illustration showing an information feed interface in which a user has viewed the information feed.

FIG. 9B is an illustration showing an information feed interface in which a user has not viewed the information feed.

FIG. 10 is a flow diagram showing aspects of a method for prioritizing a message, in accordance with some embodiments.

FIG. 11 is a flow diagram showing aspects of a method for bumping a message, in accordance with some embodiments.

FIG. 12 illustrates an illustrative computer architecture for a device capable of executing the software components described herein for prioritizing messages and bumping messages in a social collaboration application.

FIG. 13 illustrates an illustrative distributed computing environment capable of executing the software components described herein for prioritizing messages and bumping messages in a social collaboration application.

### DETAILED DESCRIPTION

Embodiments of the disclosure presented herein encompass technologies for a communication and notification system for use in a social collaboration application. In general, a user may initiate a social collaboration application on their computing device. The social collaboration application may allow the user to receive and share information from and to other users. The collaboration device may be configured to receive an input from a user that the user wishes to provide a priority notification to one or more second users to which the user is connected to through the collaboration application. The collaboration application can be configured to provide a notification feed and an information feed. A message indicating that the user has prioritized, or “shouted,” can be displayed in the one or more second users' notification feeds. Further, the message that is prioritized can be modified to indicate that the message has been prioritized, or shouted. These and other aspects are described in more detail in reference to various figures. As used herein, a “message” includes information received from a user.

As used herein, an “information feed” is a communication generated by a social collaboration application that includes the message. In some examples, a message and an information feed may be functionally the same. In other examples, the message may be placed in format required by a social collaboration application, whereby the information feed includes the message in a formatted state. The information feed may also include additional information, such as the time the message was received, the identification of a user that generated the message, a bump status, a shout status, and the like.

In the following detailed description, references are made to the accompanying drawings that form a part hereof, and in which are shown by way of illustration specific embodiments or examples. Referring now to the drawings, aspects of an exemplary operating environment and some example implementations provided herein will be described.

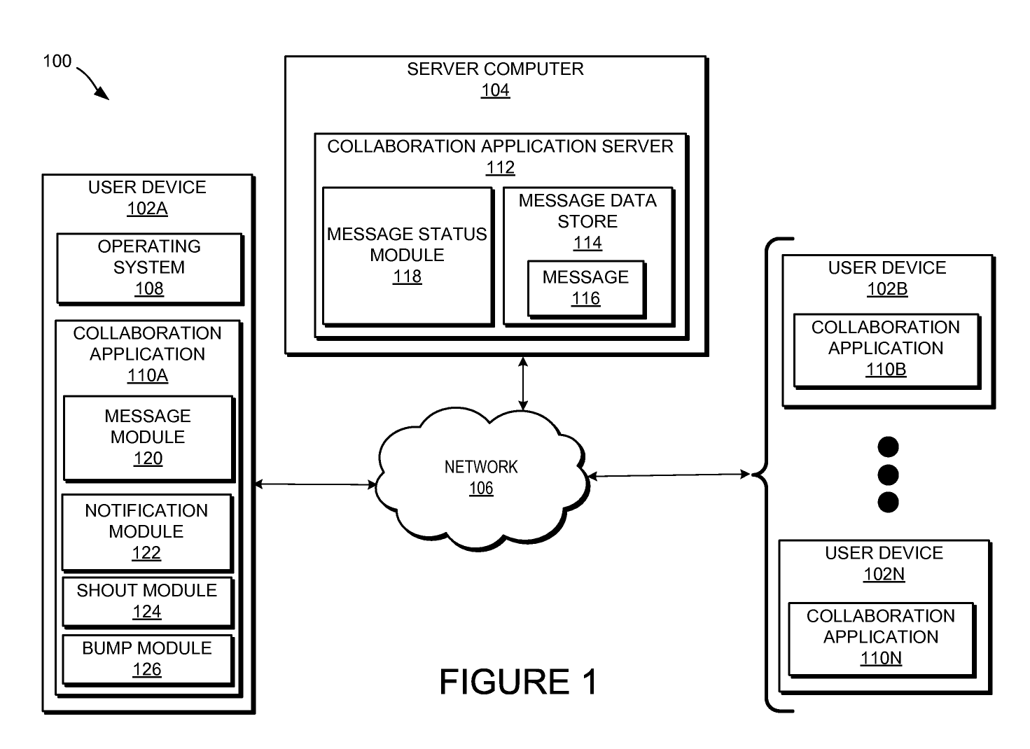

FIG. 1 is system diagram showing one illustrative operating environment 100 that may be used to implement various embodiments described herein. The operating environment 100 may include user devices 102A-102N (hereinafter referred to collectively and/or generically as “the user devices 102” and individually as “the user device 102A,” “the user device 102B,” and so forth). The operating environment 100 can include a server computer 104. The user devices 102 and/or the server computer 104 are not limited to any particular type or configuration of computing platform. Further, the user devices 102 and/or the server computer 104 may be one or more computing devices that, when implemented together, may be used as a user devices 102 and/or a server computer 104. The user devices 102 and/or the server computer 104 may be implemented in various forms, including, but not limited to, a mobile device, a cell phone, a tablet computer, a desktop computer, a laptop computer, a watch in communication with a mobile telecommunication device, a wearable device in communication with a computing device, a wearable headset capable of rendering images, the wearable headset in communication with a computing device, and the like. The presently disclosed subject matter is not limited to any particular implementation.

The user device 102 may be placed in communication with the server computer 104 using a network 106. FIG. 1 illustrates one network 106 and one server computer 104. It should be understood, however, that some implementations of the operating environment 100 include multiple networks 106 and/or multiple server computers 104. The illustrated examples described above and shown in FIG. 1 should be understood as being illustrative, and should not be construed as being limiting in any way. It should be understood that the technologies disclosed herein are not limited to an operating environment 100 connected to a network or any external computing system, as various embodiments of the technologies disclosed herein can be implemented locally on the user devices 102 and/or the server computer 104.

The user device 102A can be configured to execute an operating system 108. The operating system 108 is a computer program for controlling the operation of the user device 102A. The user device 102A may be configured to initiate and execute a collaboration application 110. In some examples, the collaboration application 110A may be a social collaboration application configured to allow the sharing of information in a social context between two or more users. Although not limited to any particular type of information, in some examples, the information may be information about the personal life of the user, a statement or status that the user wishes to share, pictures, and other types of information. The presently disclosed subject matter is not limited to any particular type of information.

In some examples, once executed by the user device 102, the collaboration application 110A may initiate a communication with a collaboration application server 112 executed by the server computer 104. The collaboration application server 112 may, among other tasks, act as a central coordinating service for the execution of collaboration application on various devices, such as the collaboration application on the user device 102A and collaboration applications 110B-110N on user devices 102B-102N. In the description provided herein, the user devices 102B-102N may be similarity configured to provide the functionality described with respect to user device 102A. It should be noted that the presently disclosed subject matter is not limited to implementations in which the collaboration application server 112 is used. In some examples, some or all of the functions provided by the collaboration application server 112 may be provided by other services, such as the collaboration application 110.

The collaboration application server 112 can include a message data store 114 that is configured to store one or more messages 116. The collaboration application 110A and/or the collaboration applications 110B-110N may communicate with the collaboration application server 112 to send and receive the message 116. The message can be various types of information. For example, the collaboration application 110A may receive an input from a user regarding comments about an event. The comments may be transmitted to the collaboration application server 112, as the message 116, which in turn determines which collaboration applications 110B-110N the message 116 should be provided. In this example, the collaboration application server 112 may determine that the message 116 about an event should be transmitted to the collaboration application 110B. The collaboration application 110B may receive the message 116 from the collaboration application server 110B and cause the message 116 to be rendered at the user device 102B.

The collaboration application server 112 can also include a message status module 118. The message status module 118 can maintain a record of the status of each of the messages 116 stored in the message data store 114. For example, the status of the message can be to which of the user devices 102 the message 116 has been provided. The status of the message 116 can also include a time or a date for which the message 116 is to be provided, and to which of the user devices 102 that message 116 is to be provided.

In a further example, the status of the message 116 can include the priority level of the message 116. For example, the message 116 may have a default priority of “normal,” whereby the message 116 is provided to a notification feed and an information feed of the various user devices 102. The collaboration application 110A can include a message module 120 that is configured to provide one or more user interfaces (not shown) to receive input of the message 116 from a user (not shown). The message module 120 can set a priority level of normal as a default setting. The message module 120 can also be configured to receive and cause to be rendered messages 116 originated at other user devices 102B-102N.

The collaboration application 110A can also include a notification module 122. The notification module 122 can be configured to receive a notification that the message 116 has been received at the user device 102A originated at other user devices 102B-102N. The message module 120 can render the message 116 when an information feed user interface (not shown) is rendered on the user device 102A. The notification module 122 can render the notification of the message 116 when a notification feed user interface (not shown) is rendered on the user device 102A.

As noted above, a default configuration may be to identify the message 116 as a normal priority communication. In some examples, however, a user may want to indicate that a particular message 116 has a higher importance or priority over other messages 116 provided by the user. In these examples, the collaboration application 110A may include a shout module 124. The shout module 124 can be configured to provide a user interface to change the priority of a particular message 116 from a normal priority to a high priority.

When invoked, the shout module 124 can provide an input to the message status module 118 that the message 116 is a high priority message. The collaboration application server 112 can also modify the message 116 that has been indicated as a high priority message so that when the message 116 is received at one or more of the user devices 102B-102N, the message 116, when displayed in an information feed on the user devices 102B-102N that received the message 116, can have an indication that the message 116 is a high priority.

In some examples, a user may want to move a message 116 previously provided to one or more of the user devices 102B-102N back to the top or near the top of the information feeds on the particular user devices 102B-102N. The collaboration application 110A may receive an input from a bump module 126 that a message 116 indicating that a message 116 previously provided to one or more user devices 102B-102N is to be placed at or near the top of the information feeds, i.e. “bump,” of the one or more user devices 102B-102N.

Upon receipt of an indication from the bump module 126 relating to a particular message 116, the collaboration application server 112 can query the message status module 118 to determine one which of the user devices 102B-102N the message 116 was received but was not rendered for display. In some examples, this may indicate that the user has not read the message 116. The message status module 118 may also determine whether or not the message 116 is permitted to be bumped. For example, the collaboration application server 112 can be configured to place a limit on a bump process. For example, a particular collaboration application may be limited as to the number of bumps per day or limited to a number of bumps in a particular time frame.

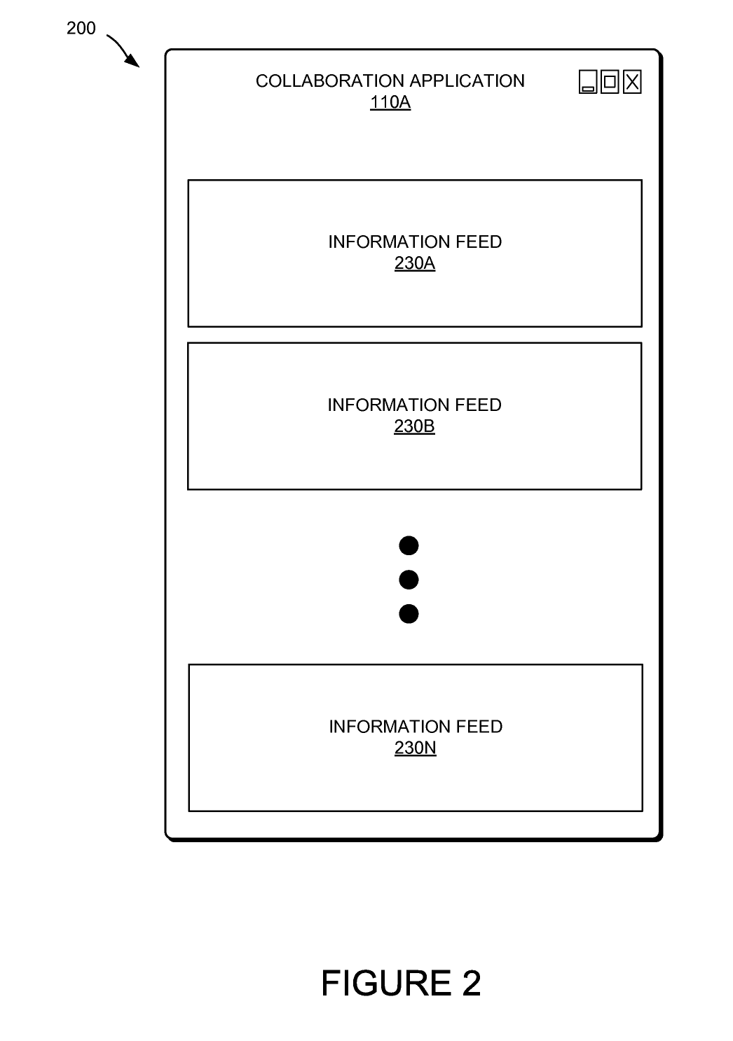

FIG. 2 is user interface diagram showing a user interface 200 for a communication and notification system for use in a social collaboration application. When executed on device, such as the user device 102A of FIG. 1, the collaboration application 110A may cause the display of one or more information feeds 230A-230N (hereinafter referred to collectively and/or generically as “the information feeds 230” and individually as “the information feed 230A,” and the like).

The information feeds 230 may be messages 116 from a user of the collaboration application 110A or users using other collaboration applications. The information feeds 230 may be text, graphics, video, and the like. As noted above, a user may wish to change a message 116 from default priority to a high priority, explained in more detail in the figures, below.

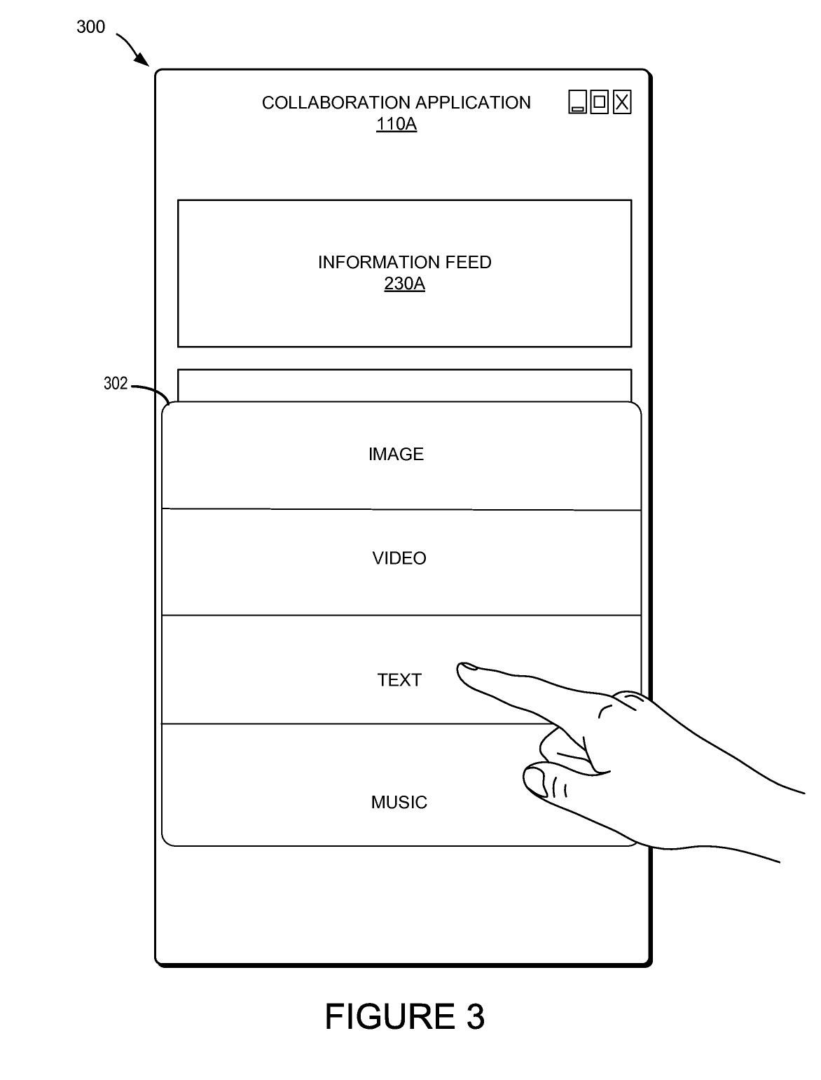

FIG. 3 is a user interface diagram showing a user interface 300 with a data type selection UI 302 used to generate a message 116. The collaboration application 110A may initiate an insert data process whereby a user inputs information to generate a message 116. In an insert data process, the collaboration application 110A may cause the display of the data type selection UI 302. The data type selection UI 302 may include selectable boxes for selecting various types of data to insert. In the example illustrated in FIG. 3, the types of data are “image,” “video,” “text,” and “music.” It should be appreciate that the types of data are merely exemplary. Once selected, the collaboration application 110A renders a message input interface.

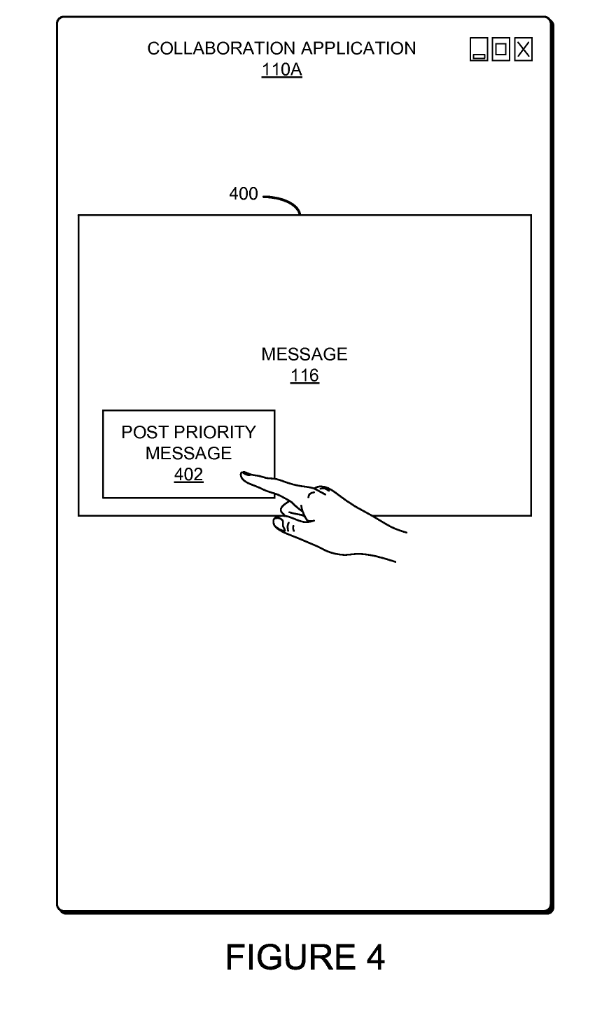

FIG. 4 is a UI diagram showing a message input interface 400. The message input interface 400 is configured to receive an input of the message 116 to be provided to one or more intended recipients of the message 116. To change the priority of the message 116 from a default priority to a high priority, the message input interface 400 can also include a post priority message interface 402. The post priority message interface can be configured to receive an input from a user to change the priority of the message 116 generated using the message input interface 400 from a default priority to a high priority, or a “shout” message. When provided to the collaboration application server 112, the message 116 will have an indication that the message 116 high priority message.

The collaboration application server 112 will receive the indication, determine which of the user devices 102B-102N is to receive the message, and send a push notification to the particular user devices 102B-102N that a high priority message has been received. A “push notification” is a delivery of information from the collaboration application server 112 to the collaboration applications 110B-110N without a specific request from the collaboration applications 110B-110N. In some examples, a user may opt into receiving a push notification or a user may opt out of receiving a push notification.

In some configurations, the collaboration applications 110 may be configured to primarily receive notifications through a pull method, whereby the collaboration applications 110 send a request for notifications from the collaboration application server 112. When using the post priority message interface 402, the collaboration application server 112 will send a notification of the priority message 116 to the particular collaboration applications 110B-110N.

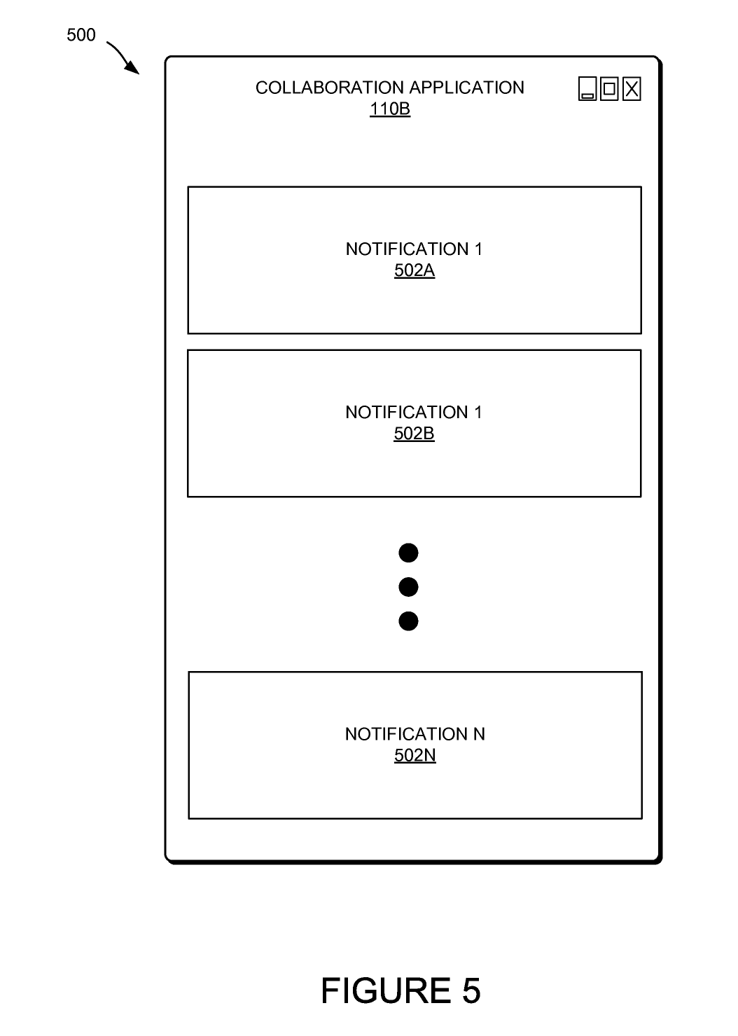

FIG. 5 is a notification user interface 500 showing notifications 502A-502N (hereinafter referred to collectively and/or generically as “the notifications 502” and individually as “the notification 502A,” “the notification 502B,” and so forth) of messages with default priorities. The notifications 502 are in their default configuration in which no indication is provided that a priority message has been received at the collaboration application server 112.

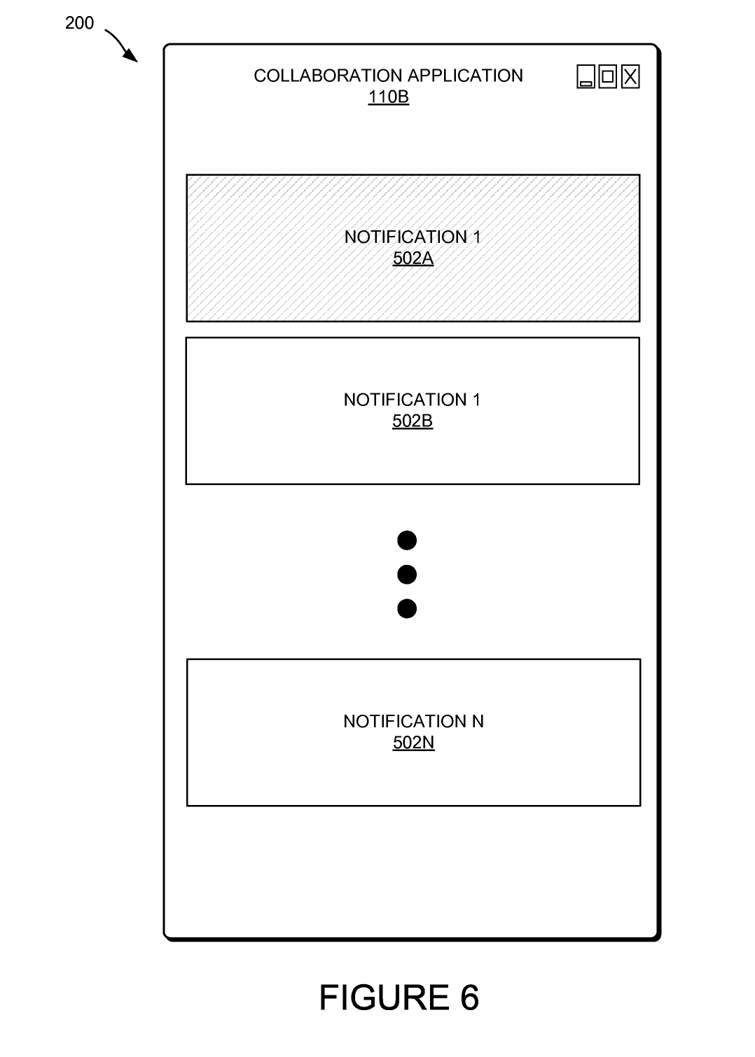

FIG. 6 is a notification user interface 600 showing notifications 502 in which notification 502A has been changed to indicate that the notification 502A is a high priority message that has been received at the collaboration application server 112. In some examples, the modification to the notification 502A can be a color, shape, text, image, as well as other possible modifications. The presently disclosed subject matter is not limited to any particular manner in which the notification 502A is modified to indicate that a high priority message has been received. In some examples, the modification may be text indicating that a particular user (the originator of the prioritized message 116) has shouted the message 116. In some examples, the message 116 as it is rendered at the recipients' device can be modified as well.

In some examples, the notification 502A includes an audio file that, when received at the user devices 102B-102N, causes the user devices 102B-102N to play the audio file. The audio file can be a default audio file that, when played, causes a particular sound. In other examples, the audio file can be a file selected or generated by a user when entering the message 116. In further examples, the notification 502A includes a video or image file that, when received at the user devices 102B-102N, causes the user devices 102B-102N to render the video or image file. The video or image file can be a default video or image file or can be a video or image file selected or generated by a user when entering the message 116. In some examples, the notification 502A may be configured to receive an input from a user in which the user can respond to the notification 502A rather than the information feed associated with the notification 502A.

In some configurations, the collaboration application server 112 may be configured to allow for the editing or replacement of a priority notification, such as the notification 502A. For example, the collaboration application 110A may receive an input that the message 116 from which the notification 502A was generated is to be changed. Various reasons for the change may include, but are not limited to, spelling or grammar errors in the message 116, incorrect information in the message 116, and the like. The presently disclosed subject matter is not limited to any particular reason.

In these examples, the collaboration application 110A may communicate an updated message 116 to the collaboration application server 112. The collaboration application server 112 may determine which collaboration applications 110B-110N received the notification 502A generated from the original message 116. The collaboration application server 112 may send an updated notification or may send a request to the particular collaboration applications 110B-110N to remove the original notification 502A and replace the original notification 502A with an updated notification 502A.

In further configurations, the notification 502A may be limited to particular collaboration applications 110B-110N. For example, the message 116 transmitted by the collaboration application 110A may be intended for a particular subset of collaboration applications 110B-110N. The subset may be based on various criteria, such as demographic data relating to the particular collaboration applications 110B-110N. In one example, it may be desired to only send the notification 502A to a specific gender, location, occupation, and the like.

In some examples, the collaboration application server 112 may have stored thereon data pertaining to the collaboration applications 110B-110N, the data being used as a filter. If the data relating to the particular one of the collaboration applications 110B-110N meets a certain criteria, the collaboration application server 112 may send the notification to those that meet the criteria. In other examples, the collaboration applications 110B-110N may act as local filters, whereby the collaboration applications 110B-110N will only display the notification 502A if the data relating to that particular one of the collaboration applications 110B-110N meet certain criteria. In these examples, the collaboration application server 112 may push the notification 502A to the group of collaboration applications 110B-110N and allow the particular one of the collaboration applications 110B-110N to make a determination as to whether or not the notification 502A should be rendered.

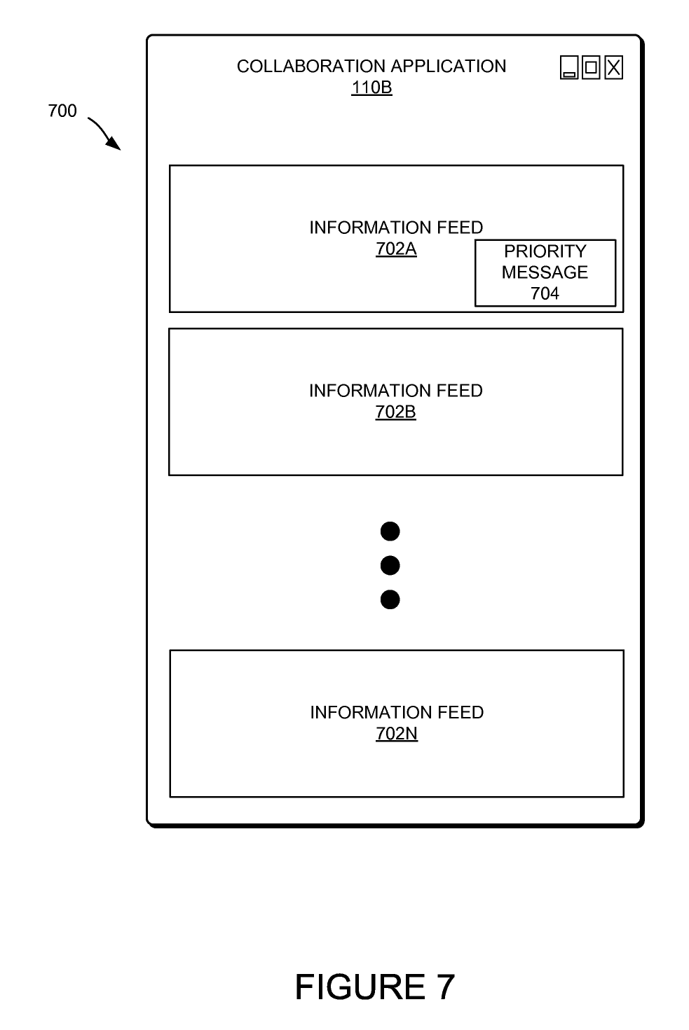

FIG. 7 is an information feed interface 700 with information feeds 702A-702N (hereinafter referred to collectively and/or generically as “the information feeds 702” and individually as “the information feed 702A,” “the information feed 702B,” and so forth). In FIG. 7, the information feed 702A corresponds to the notification 502A of FIG. 6. As discussed above, the notification 502A of FIG. 6 indicates that a message 116 has been prioritized. When displayed in the information feed interface 700 as the information feed 702A, the information feed 702A may include a priority message notification 704 indicating that the information feed 702A formed from the message 116 has been prioritized.

In some examples, a user may want to move a previously posted message 116 to the top of the information feed interface 700 of a recipient of the message 116. In some examples, the information feeds 702 will be queued according to the time in which the information feeds 702 were received at the collaboration application server 112 for a particular one of the user devices 102. Because the user devices 102 may receive messages 116 from multiple other devices, the information feed 702 for a particular message 116 may end up in an unfavorable position in the information feed interface 700.

For example, messages 116 received but not read for a period of time may end up at the bottom of the information feed interface 700. A user viewing the information feeds 702 may not notice a particular information feed 702 because the information feed 702. Thus, a user may want to bump the information feed to the top or near the top of the information feed interface 700 for the recipients of the message that have not viewed the message 116. In some examples, a view of a message may be completed when the message 116 of the information feed 702 is rendered in a display of a user device 102.

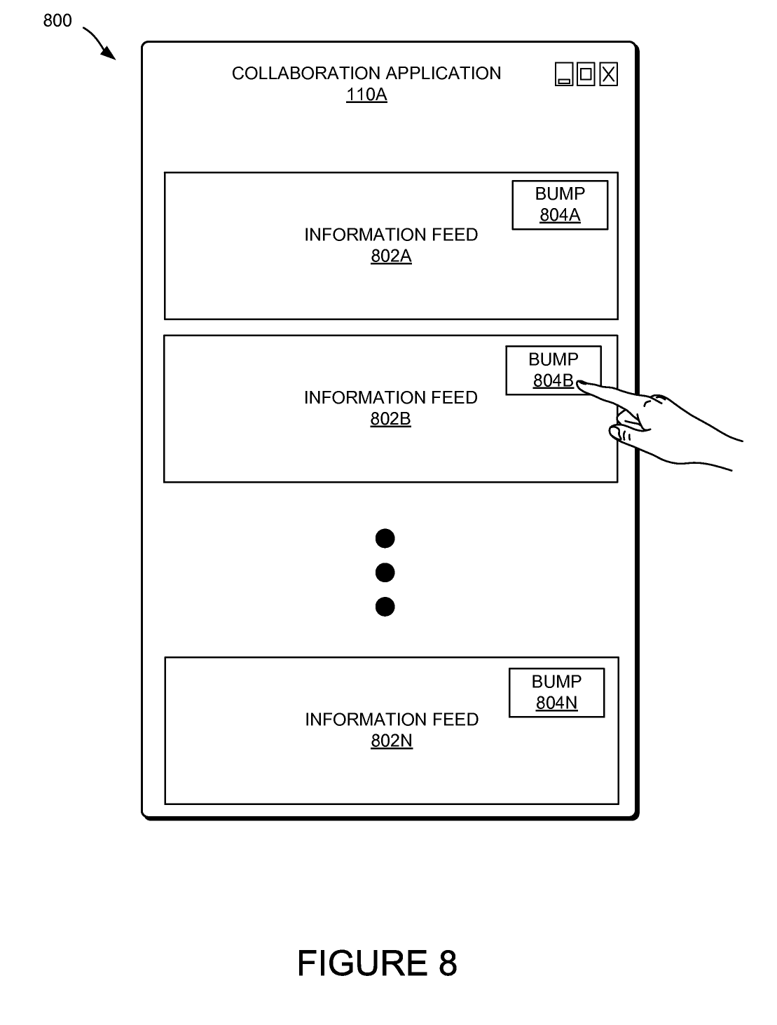

FIG. 8 is an illustration of a postings interface 800 showing a bump feature. The postings interface 800 includes information feeds 802A-802N (hereinafter referred to collectively and/or generically as “the information feeds 802” and individually as “the information feed 802A,” “the information feed 802B,” and so forth) originated by the user of the collaboration application 110A. The information feeds 802 include bump interfaces 804A-804N (hereinafter referred to collectively and/or generically as “the bump interfaces 804” and individually as “the bump interface 804A,” “the bump interface 804B,” and so forth).

In one example, a user may which to bump the information feed 802B to the top of information feed interfaces of recipients of the information feed 802B that have not viewed the information feed 802B. The bump interface 804B may be configured to receive an input that the bump feature is to be used. Once received, the collaboration application 110A will transmit a message to the collaboration application server 112 that the information feed 802B is to be bumped. The message status module 118 will determine in which of the collaboration applications 802B-802N received the information feed 802B but was not viewed. The message status module 118 may also determine if the bump feature is available. If the bump feature is available for use, the collaboration application server 112 will use the information determined by the message status module 118 and move the information feed 802B to the top of the message feed interfaces of the user devices 102B-102N that have received but have not indicated that the information feed 802B was viewed.

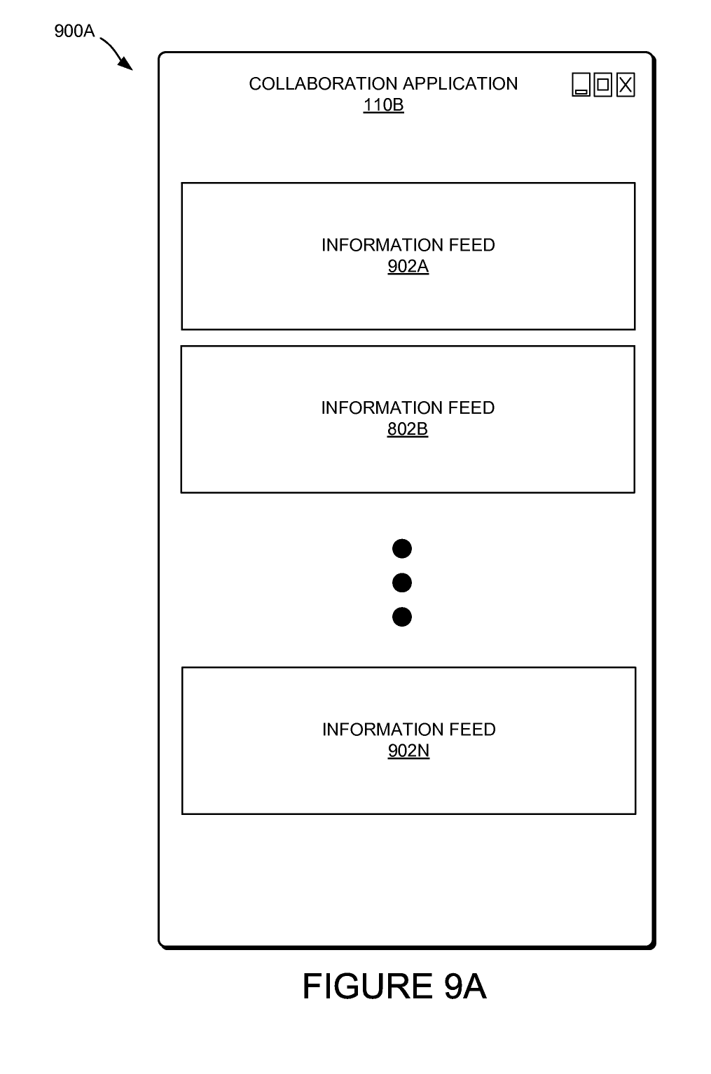

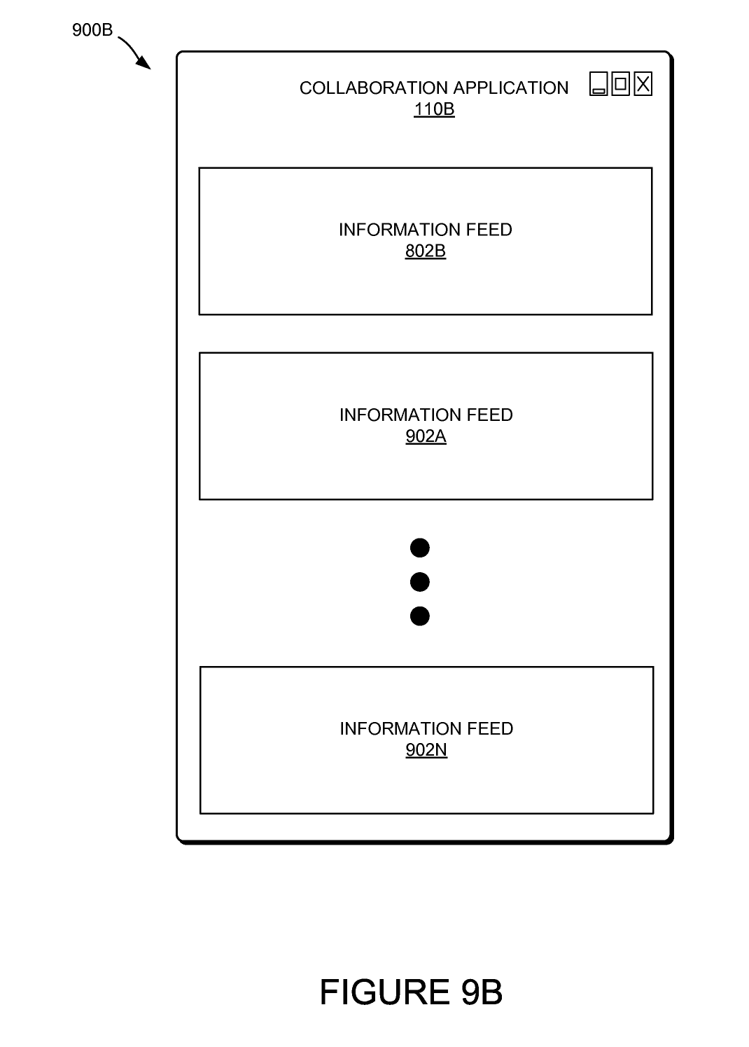

FIG. 9A is an illustration showing an information feed interface 900A in which a user has viewed the information feed 802B. In the example illustrated in FIG. 9A, because the information feed 802B was indicated as being viewed, the information feed 802B was not placed in a higher position than the feed 902A and 902N.

FIG. 9B is an illustration showing an information feed interface 900B in which a user has not viewed the information feed 802B. In the example illustrated in FIG. 9B, because the information feed 802B was indicated as not being viewed, the information feed 802B was placed in a higher position than the feed 902A and 902N and placed at the top of the information feed interface 900B. In FIG. 9B, the information feed 802B has been modified with bump notification 904 to indicate that the information feed 802B has been bumped.

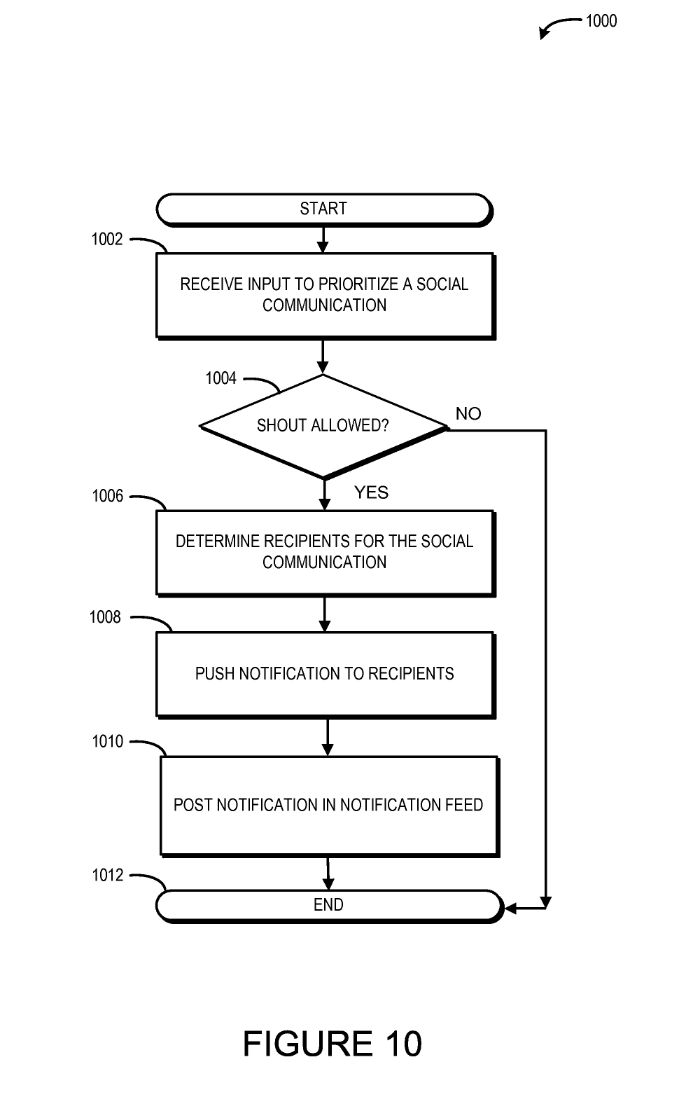

FIG. 10 is a flow diagram showing aspects of a method 1000 for prioritizing a message 116, in accordance with some embodiments. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

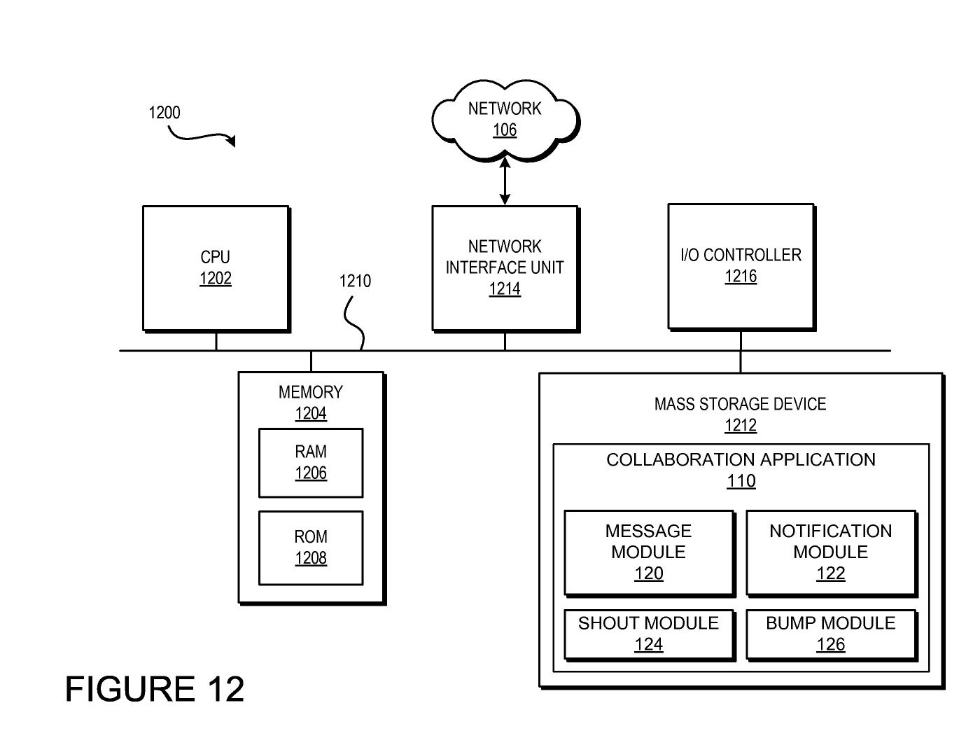

The operations of the method 1000 are described herein below as being implemented, at least in part, by a computing device 1200 (described below with regard to FIG. 12). One or more of the operations of the method 1000 may alternatively or additionally be implemented, at least in part, by the similar components in either computing device 1100 or a similarly configured server computer providing the operating environment 100.

Now with reference to FIG. 10, the method 1000 begins and proceeds to operation 1002, where an input is received to prioritize a social communication. The social communication can be the message 116 received at the collaboration application 110A. The message can be information about the personal life of the user, a statement or status that the user wishes to share, pictures, music, videos, and other types of information.

The method 1000 proceeds to operation 1004, where a determination is made as to whether or not the message can be prioritized. In some configurations, a particular user may be granted the ability to prioritize their messages at a particular rate. For example, a user may have the ability to shout a message (i.e. prioritize a message) once per 24 hour cycle, whereby prioritization is permitted once per rolling 24 hours. If the prioritization is not allowed at operation 1004, the method 1000 can end thereafter. In some configurations, a message may be provided indicating the inability to prioritize a message. In other configurations, if the user is in a particular pause period, in which a prioritization is not allowed, the collaboration application 110A may be configured so that the priority message interface 402 is either not shown or is configured to not receive an input.

If prioritization is allowed at operation 1004, the method 1000 continues to operation 1006, where the collaboration application server 112 determines recipients for the message and the notification of the prioritized message. As noted before, the notification may be sent to the collaboration applications 110B-110N that have been configured to receive notifications and message from the collaboration application 110A. In some configurations, the notification of the prioritized message may be pushed to a subset of the collaboration applications 110B-110N that have been configured to receive notifications and message from the collaboration application 110A.

The method 1000 continues to operation 1008, where the collaboration application server 112 pushes the notification of the prioritized message to the recipients identified in operation 1004.

The method 1000 continues to operation 1010, where the notification of the prioritized message is posted in the notification feeds of the recipients determined in operation 1006. The method 1000 thereafter ends.

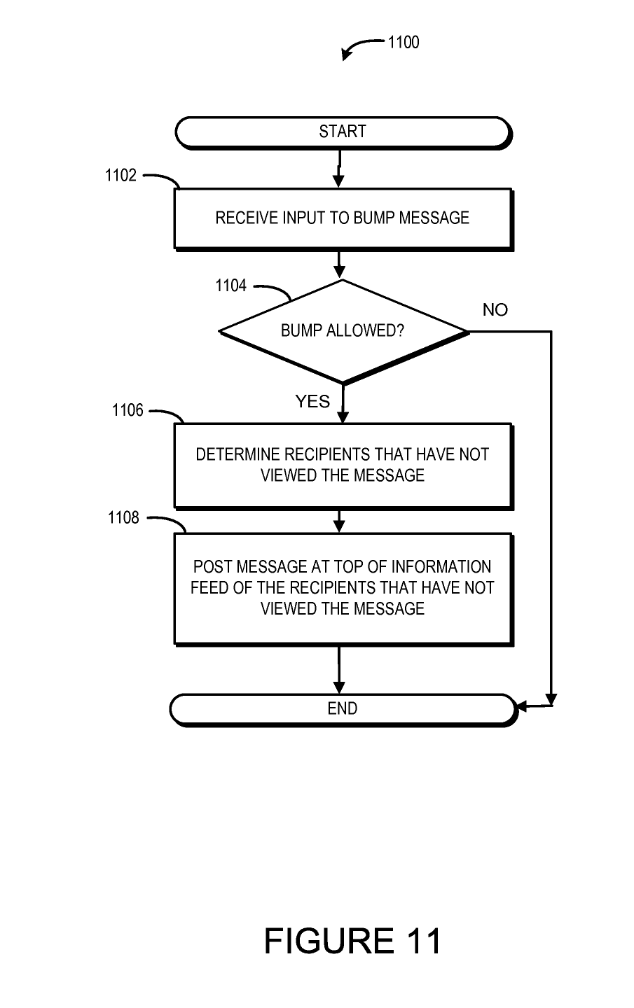

FIG. 11 is a flow diagram showing aspects of a method 1100 for bumping a message, in accordance with some embodiments.

The method 1100 commences at operation 1102, an input is received to bump a message 116. Bumping the message 116 may move the message to the top or near the top of information feeds of recipients of the message that have not viewed the message.

The method 1100 proceeds to operation 1104, a determination is made as to whether or not a bump is allowed. In some configurations, a particular user may be granted the ability to bump a message at a particular rate. For example, a user may have the ability to bump a message (i.e. prioritize a message) once per 24 hour cycle. If the bump is not allowed at operation 1104, the method 1100 can end thereafter. In some configurations, a message may be provided indicating the inability to bump a message. In other configurations, if the user is in a particular pause period, in which a bump is not allowed, the collaboration application 110A may be configured so that the bump interface 804 is either not shown or is configured to not receive an input.

If bumping is allowed, the method 1100 proceeds to operation 1106, where the collaboration application server determines which recipients of the message to be bumped have not viewed the message.

The method 1100 proceeds to operation 1108, where the message is posted at the top or near the top of the information feeds for the recipients that have not viewed the message. The method 1100 thereafter ends.

FIG. 12 illustrates an illustrative computer architecture 1200 for a device capable of executing the software components described herein for prioritizing messages and bumping messages in a social collaboration application. Thus, the computer architecture 1200 illustrated in FIG. 12 illustrates an architecture for a server computer, mobile phone, a PDA, a smart phone, a desktop computer, a netbook computer, a tablet computer, and/or a laptop computer. The computer architecture 1200 may be utilized to execute any aspects of the software components presented herein.

The computer architecture 1200 illustrated in FIG. 12 includes a central processing unit 1202 (“CPU”), a system memory 1204, including a random access memory 1206 (“RAM”) and a read-only memory (“ROM”) 1208, and a system bus 1210 that couples the memory 1204 to the CPU 1202. A basic input/output system containing the basic routines that help to transfer information between elements within the computer architecture 1200, such as during startup, is stored in the ROM 1208. The computer architecture 1200 further includes a mass storage device 1212 for storing the collaboration applications 110, the message module 120, the notification module 122, the shout module 124, and the bump module 126.

The mass storage device 1212 is communicatively connected to the CPU 1202 through a mass storage controller (not shown) connected to the bus 1210. The mass storage device 1212 and its associated computer-readable media provide non-volatile storage for the computer architecture 1200. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 1200.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 1200. For purposes the claims, the phrase “computer storage medium” and variations thereof, does not include waves, signals, and/or other transitory and/or intangible communication media, per se.

According to various embodiments, the computer architecture 1200 may operate in a networked environment using logical connections to remote computers through a network such as the network 106. The computer architecture 1200 may connect to the network 106 through a network interface unit 1214 connected to the bus 1210. It should be appreciated that the network interface unit 1214 also may be utilized to connect to other types of networks and remote computer systems. The computer architecture 1200 also may include an input/output controller 1216 for receiving and processing input from a number of other devices, including a keyboard, mouse, or electronic stylus (not shown in FIG. 12). Similarly, the input/output controller 1216 may provide output to a display screen, a printer, or other type of output device (also not shown in FIG. 12).

It should be appreciated that the software components described herein may, when loaded into the CPU 1202 and executed, transform the CPU 1202 and the overall computer architecture 1200 from a general-purpose computing system into a special-purpose computing system customized to facilitate the functionality presented herein. The CPU 1202 may be constructed from any number of transistors or other discrete circuit elements, which may individually or collectively assume any number of states. More specifically, the CPU 1202 may operate as a finite-state machine, in response to executable instructions contained within the software modules disclosed herein. These computer-executable instructions may transform the CPU 1202 by specifying how the CPU 1202 transitions between states, thereby transforming the transistors or other discrete hardware elements constituting the CPU 1202.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 1200 in order to store and execute the components presented herein. It also should be appreciated that the computer architecture 1200 may include other types of computing devices, including hand-held computers, embedded computer systems, personal digital assistants, and other types of computing devices known to those skilled in the art. It is also contemplated that the computer architecture 1200 may not include all of the components shown in FIG. 12, may include other components that are not explicitly shown in FIG. 12, or may utilize an architecture completely different than that shown in FIG. 12.

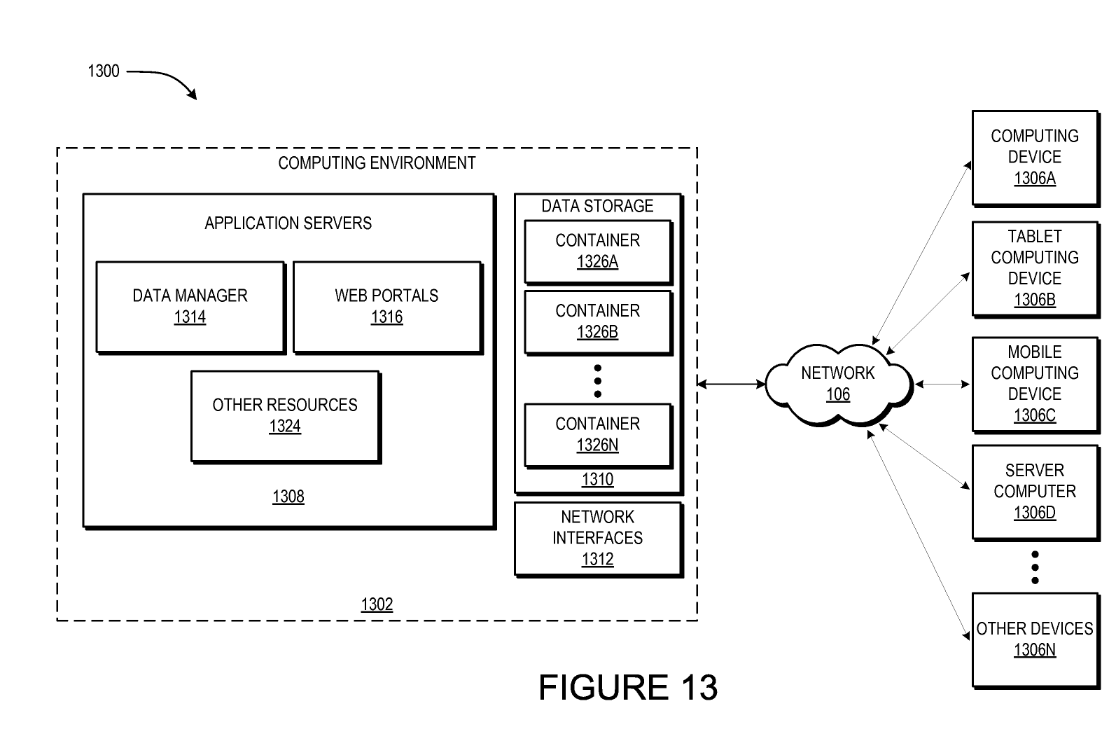

FIG. 13 illustrates an illustrative distributed computing environment 1300 capable of executing the software components described herein for prioritizing messages and bumping messages in a social collaboration application, in accordance with some embodiments. Thus, the distributed computing environment 1300 illustrated in FIG. 13 can be used to provide the functionality described herein with respect to the user devices 102 and the server computer 104. The distributed computing environment 1300 thus may be utilized to execute any aspects of the software components presented herein.

According to various implementations, the distributed computing environment 1300 includes a computing environment 1302 operating on, in communication with, or as part of the network 106. The network 106 also can include various access networks. One or more client devices 1306A-1306N (hereinafter referred to collectively and/or generically as “clients 1306”) can communicate with the computing environment 1302 via the network 106 and/or other connections (not illustrated in FIG. 13). In the illustrated embodiment, the clients 1306 include a computing device 1306A such as a laptop computer, a desktop computer, or other computing device; a slate or tablet computing device (“tablet computing device”) 1306B; a mobile computing device 1306C such as a mobile telephone, a smart phone, or other mobile computing device; a server computer 1306D; and/or other devices 1306N. It should be understood that any number of clients 1306 can communicate with the computing environment 1302. It should be understood that the illustrated clients 1306 and computing architectures illustrated and described herein are illustrative, and should not be construed as being limited in any way.

In the illustrated embodiment, the computing environment 1302 includes application servers 1308, data storage 1310, and one or more network interfaces 1312. According to various implementations, the functionality of the application servers 1308 can be provided by one or more server computers that are executing as part of, or in communication with, the network 1304. The application servers 1308 can host various services, virtual machines, portals, and/or other resources. In the illustrated embodiment, the application servers 1308 host one or more virtual machines 1314 for hosting applications or other functionality. According to various implementations, the virtual machines 1314 host one or more applications and/or software modules for providing the functionality described herein. It should be understood that this embodiment is illustrative, and should not be construed as being limiting in any way. The application servers 1308 also host or provide access to one or more Web portals, link pages, Web sites, and/or other information (“Web portals”) 1316.

As shown in FIG. 13, the application servers 1308 also can host other services, applications, portals, and/or other resources (“other resources”) 1324. It thus can be appreciated that the computing environment 1302 can provide integration of the concepts and technologies disclosed herein provided herein. It should be understood that these embodiments are illustrative, and should not be construed as being limiting in any way.

As mentioned above, the computing environment 1302 can include the data storage 1310. According to various implementations, the functionality of the data storage 1310 is provided by one or more databases operating on, or in communication with, the network 1304. The functionality of the data storage 1310 also can be provided by one or more server computers configured to host data for the computing environment 1302. The data storage 1310 can include, host, or provide one or more real or virtual datastores 1326A-1326N (hereinafter referred to collectively and/or generically as “datastores 1326”). The datastores 1326 are configured to host data used or created by the application servers 1308 and/or other data.

The computing environment 1302 can communicate with, or be accessed by, the network interfaces 1312. The network interfaces 1312 can include various types of network hardware and software for supporting communications between two or more computing devices including, but not limited to, the clients 1306 and the application servers 1308. It should be appreciated that the network interfaces 1312 also may be utilized to connect to other types of networks and/or computer systems.

It should be understood that the distributed computing environment 1300 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1300 provides the software functionality described herein as a service to the clients 1306.

It should be understood that the clients 1306 can include real or virtual machines including, but not limited to, server computers, web servers, personal computers, mobile computing devices, smart phones, and/or other devices. As such, various embodiments of the concepts and technologies disclosed herein enable any device configured to access the distributed computing environment 1300 to utilize the functionality described herein.

Based on the foregoing, it should be appreciated that technologies for prioritizing messages and bumping messages in a social collaboration application have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method, comprising:
receiving an input that a message is to be a priority message;
determining if prioritization is permitted;
if prioritization is permitted
generating a notification for the priority message,
determining one or more recipients to receive the priority message, and
pushing the notification for the priority message to the one or more recipients to receive the priority message.

2. The computer-implemented method of claim 1, wherein determining if prioritization is permitted comprises determining if the input is received during a pause period during which prioritization is not permitted.

3. The computer-implemented method of claim 2, wherein the pause period comprises a 24 hour cycle, whereby prioritization is permitted once per rolling 24 hours.

4. The computer-implemented method of claim 1, further comprising receiving an input to modify the notification.

5. The computer-implemented method of claim 4, further comprising generating a modified notification and pushing the modified notification to the one or more recipients.

6. The computer-implemented method of claim 5, further comprising causing the removal of the notification in conjunction with the pushing of the modified notification.

7. The computer-implemented method of claim 1, further comprising generating an information feed based on the message, whereby the information feed is modified to indicate that the message is a prioritized message.

8. The computer-implemented method of claim 1, wherein the message comprises information about a user, a statement or a status that the user wishes to share, a picture, music, and a video.

9. The computer-implemented method of claim 1, determining one or more recipients to receive the priority message is based on a demographic of the recipient, where the notification is pushed to recipients that meet certain demographic criteria.

10. A computing system, the computing system comprising:
a processor; and
a computer-readable storage medium having computer-executable instructions stored thereupon which, when executed on the processor, cause the processor to
receive an input that a message is to be a priority message;
determine if prioritization is permitted;
if prioritization is permitted
generate a notification for the priority message,
determine one or more recipients to receive the priority message, and
push the notification for the priority message to the one or more recipients to receive the priority message.

11. The computing system of claim 10, wherein the instructions to determine if prioritization is permitted comprises instructions to determine if the input is received during a pause period during which prioritization is not permitted.

12. The computing system of claim 11, wherein the pause period comprises a 24 hour cycle, whereby prioritization is permitted once per rolling 24 hours.

13. The computing system of claim 10, further comprising instructions to receive an input to modify the notification.

14. The computing system of claim 13, further comprising computer instructions to generate a modified notification and push the modified notification to the one or more recipients.

15. The computing system of claim 14, further comprising instructions to remove the notification in conjunction with the pushing of the modified notification.

16. The computing system of claim 10, further comprising instructions to generate an information feed based on the message, whereby the information feed is modified to indicate that the message is a prioritized message.

17. The computing system of claim 10, wherein the message comprises information about a user, a statement or a status that the user wishes to share, a picture, music, and a video.

18. The computing system of claim 10, further comprising instructions to determine one or more recipients to receive the priority message based on a demographic of the recipient, where the notification is pushed to recipients that meet certain demographic criteria.

19. A computer-readable storage medium having computer-executable instructions stored thereupon which, when executed by one or more processors, cause the one or more processors to:
receive an input that a message is to be a priority message;
determine if prioritization is permitted;
if prioritization is permitted
generate a notification for the priority message,
determine one or more recipients to receive the priority message, and
push the notification for the priority message to the one or more recipients to receive the priority message.
